(19) United States
(12) Patent Application Publication
(10) Pub. No.: US 2022/0318374 A1
(43) Pub. Date: Oct. 6, 2022

(54) DIAGNOSIS APPARATUS, DIAGNOSIS METHOD, AND COMPUTER-READABLE RECORDING MEDIUM

(71) Applicant: YOKOGAWA ELECTRIC CORPORATION, Tokyo (JP)

(72) Inventor: Tsuyoshi KATO, Tokyo (JP)

(21) Appl. No.: 17/687,216

(22) Filed: Mar. 4, 2022

(30) Foreign Application Priority Data
Mar. 30, 2021 (JP) 2021-058542

(51) Int. Cl. G06F 21/54; G06F 21/55; G06F 21/57; G06F 11/30

(52) U.S. Cl. CPC G06F 21/54; G06F 21/554; G06F 21/577; G06F 11/3051

(57) ABSTRACT

A diagnosis apparatus includes a memory unit that, for each control apparatus which performs control and monitoring of an apparatus installed in a plant for running the plant, is used to store configuration information related to each configuration of the control apparatus to be subjected to security diagnosis, a receiving unit that receives, from the control apparatus, diagnosis information of the each configuration as collected by the control apparatus, and a diagnosing unit that performs security diagnosis of the control apparatus based on the received diagnosis information and the configuration information.

### CROSS-REFERENCE TO RELATED APPLICATION

The present application claims priority to and incorporates by reference the entire contents of Japanese Patent Application No. 2021-058542 filed in Japan on Mar. 30, 2021.

### FIELD

The present invention is related to a diagnosis apparatus, a diagnosis method, and a computer program product.

### BACKGROUND

In a control system installed in a plant, security diagnosis needs to be performed with respect to the control apparatuses in operation. Herein, the control apparatuses imply apparatuses such as virtual computers and physical computers that are built using, for example, a general-purpose operating system (OS). Moreover, security diagnosis implies, for example, the action of detecting information such as apparatus-specific information, system configuration, processes, networks, accounts, and file information indicating the state of the control apparatuses; and observing that no unpredicted changes are occurring. A security diagnosis system has the mechanism for visualizing such security diagnosis information and for notifying the occurrence of any change and registering its determination result.
[Patent Literature 1] Japanese Patent Application Laid-open No. 2016-184194

However, in the security diagnosis, it is difficult to reduce the impact exerted on the operations of the control system due to the introduction of a diagnosis system. That is because, in the technology mentioned above, the involvement of a detection driver and a validation application, which are used in performing security validation, results in a delay in the operations of the control software and results in blocking the normal operations due to the false detections made by the validation application.

### SUMMARY

According to an aspect of an embodiment, a diagnosis apparatus includes a memory unit that, for each control apparatus which performs control and monitoring of an apparatus installed in a plant for running the plant, is used to store configuration information related to each configuration of the control apparatus to be subjected to security diagnosis, a receiving unit that receives, from the control apparatus, diagnosis information of the each configuration as collected by the control apparatus, and a diagnosing unit that performs security diagnosis of the control apparatus based on the received diagnosis information and the configuration information.

According to an aspect of an embodiment, a diagnosis method includes storing, for each control apparatus which performs control and monitoring of an apparatus installed in a plant for running the plant, configuration information related to each configuration of the control apparatus to be subjected to security diagnosis, receiving, from the control apparatus, diagnosis information of the each configuration as collected by the control apparatus; and performing security diagnosis of the control apparatus based on the received diagnosis information and the configuration information.

According to an aspect of an embodiment, a computer-readable recording medium stores therein a control program configured to cause a computer to execute storing, for each control apparatus which performs control and monitoring of an apparatus installed in a plant for running the plant, configuration information related to each configuration of the control apparatus to be subjected to security diagnosis, receiving, from the control apparatus, diagnosis information of the each configuration as collected by the control apparatus, and performing security diagnosis of the control apparatus based on the received diagnosis information and the configuration information.

According to the present invention, in the security diagnosis, it becomes possible to reduce the impact exerted on the operations of the control system due to the introduction of the diagnosis system.

### BRIEF DESCRIPTION OF THE DRAWINGS

FIG. 1 is a diagram illustrating an exemplary configuration of a security diagnosis system according to an embodiment;

FIG. 2 is a diagram illustrating the overview of the conventional security validation;

FIG. 3 is a block diagram illustrating an exemplary configuration of various apparatuses according to the embodiment;

FIG. 4 is a flowchart for explaining an exemplary overall flow of a security diagnosis operation performed according to the embodiment;

FIG. 5 is a sequence diagram illustrating an exemplary flow of a DB creation operation according to the embodiment;

FIG. 6 is a sequence diagram illustrating an exemplary flow of a periodic diagnosis operation performed according to the embodiment;

FIG. 7 is a sequence diagram illustrating an exemplary flow of a normal diagnosis operation performed according to the embodiment;

FIG. 8 is a sequence diagram illustrating an exemplary flow of an interim diagnosis operation performed according to the embodiment;

FIG. 9 is a sequence diagram illustrating an exemplary flow of a feedback operation performed according to the embodiment; and

FIG. 10 is a diagram illustrating an exemplary hardware configuration.

### DETAILED DESCRIPTION OF THE PREFERRED EMBODIMENTS

An exemplary embodiment of a security diagnosis apparatus (also called a diagnosis apparatus), a security diagnosis method (also called a diagnosis method), and a computer program product according to the present invention is described below in detail with reference to the accompanying drawings. However, the present invention is not limited by the embodiment described below.

### Embodiment

In the following explanation, a configuration of a security diagnosis system according to the embodiment, the overview of the conventional security validation, a configuration of a security diagnosis apparatus, and the flow of various operations are explained in that order. Lastly, the explanation is given about the effects achieved in the embodiment.

[Configuration of Security Diagnosis System]

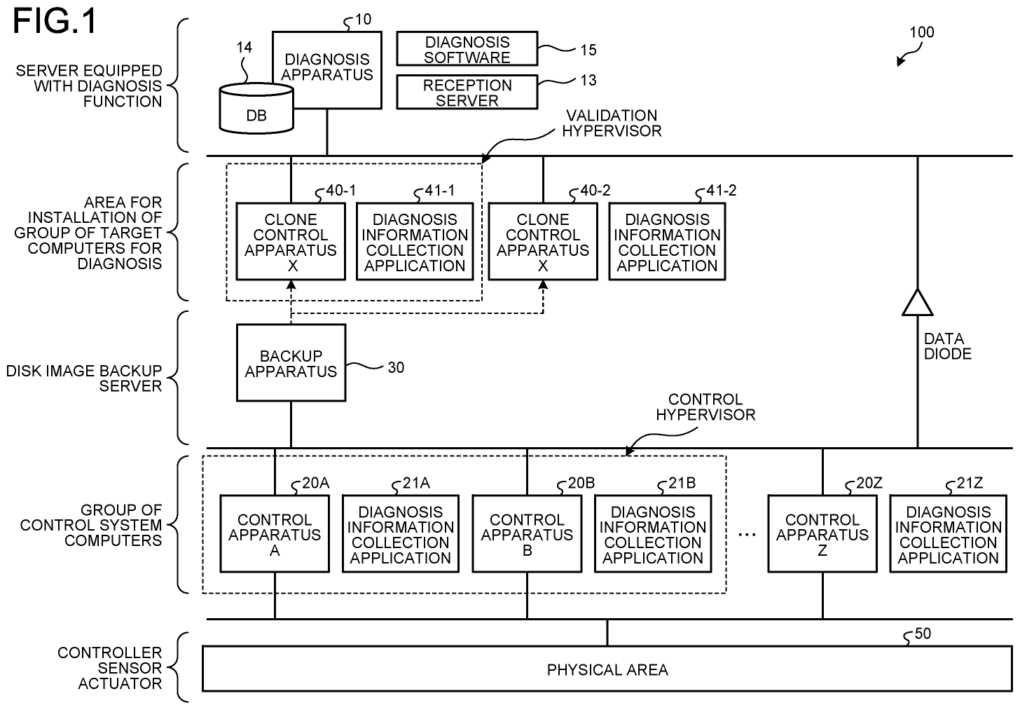

Explained below with reference to FIG. 1 is a detailed configuration of a security diagnosis system 100 (also called a concerned system 100) according to the embodiment. FIG. 1 is a diagram illustrating an exemplary configuration of the security diagnosis system according to the embodiment. In the following explanation, an exemplary overall configuration of the concerned system 100 is explained, and then the operations performed by the apparatuses are explained.

(Exemplary Overall Configuration of System)

The concerned system 100 is used in diagnosing the security of the apparatuses involved in the operations and the control of a plant. For example, the concerned system 100 includes a diagnosis apparatus 10 such as a server that is equipped with a diagnosis function; control apparatuses 20 (20A, 20B, . . . , 20Z) representing a group of control system computers; a backup apparatus 30 such as a desk image backup server; clone control apparatuses 40 that are cloned in the regions meant for installing computer groups to be diagnosed; and a physical area 50 having a controller, a sensor, and an actuator. The diagnosis apparatus 10, the control apparatuses 20, the backup apparatuses 30, the clone control apparatuses 40, and the physical area 50 are communicably connected to each other in a wired manner or a wireless manner via a predetermined communication network (not illustrated). Meanwhile, the diagnosis system 100 illustrated in FIG. 1 can include a plurality of diagnosis apparatuses 10, a plurality of backup apparatuses 30, and a plurality of physical areas 50.

In the concerned system 100, the following operations are performed: a configuration information master database creation operation (also referred to as a “DB creation operation”); a diagnosis operation; and a feedback operation. Firstly, the diagnosis apparatus 10 receives information about security diagnosis (also referred to as “information about diagnosis” or “diagnosis information”) collected by the clone control apparatus 40 regarding each target control apparatus 20 for diagnosis; registers the received information as configuration information; and creates a configuration information master database (also referred to as a “master database”) 14 (i.e., the DB creation operation). Then, the diagnosis apparatus 10 performs security diagnosis by: receiving the diagnosis information collected by the control apparatus 20 or the clone control apparatus 40; comparing the received diagnosis information with the configuration information registered in the master database 14; and outputting difference information (i.e., the diagnosis operation). Subsequently, the diagnosis apparatus 10 receives a determination result about the result of security diagnosis from a security diagnosis result supervisor (also referred to as a “diagnosis result supervisor”) 90; and performs security diagnosis feedback (i.e., the feedback operation).

(Diagnosis Apparatus 10)

The diagnosis apparatus 10 is a computer that provides a security diagnosis function; that is installed in a network which is independent of the group of control system computers; and that is controlled by a data diode from the network for the group of control system computers, so as not to ensure that no information can be sent to the control system. The diagnosis apparatus 10 includes diagnosis software 15, a reception server 13, and a database (DB) 14 for storing information. Meanwhile, with reference to FIG. 1, the diagnosis apparatus 10 is installed on the outside of a server apparatus that provides a virtual computer for the clone control apparatuses 40 (i.e., on the outside of a validation hypervisor). However, alternatively, the diagnosis apparatus 10 can be configured as a virtual computer inside the validation hypervisor.

The diagnosis software 15 performs security diagnosis, displays the diagnosis result, and performs feedback to the diagnosis result. Moreover, the diagnosis software 15 has a user interface for displaying the diagnosis result; and is equipped with a function of notifying malfunctioning when detected.

The reception server 13 receives information from diagnosis information collection applications 21 and 41. Then, the reception server 13 sends the received information to the diagnosis software 15. Moreover, the information received by the reception server 13 is stored in the database 14.

The database 14 is used to store the information about the control apparatuses 20 as collected by the diagnosis information collection applications 21 and 41 and by the reception server 13.

(Control Apparatuses 20)

The control apparatuses 20 are computer apparatuses for which security validation is to be performed. The number of the installed control apparatuses 20 varies according to the scale of the control system. With reference to FIG. 1, a control apparatus A 20A and a control apparatus B 20B are built as virtual computers (operation hypervisors); while a control apparatus Z 20Z is built as a physical computer.

The following explanation is given about the features of the computers used as the control apparatuses 20. However, there is no restriction on the control apparatuses 20 used in the embodiment. Firstly, the control apparatuses 20 are different than the computers used in general-purpose office automation (OA); and represent dedicated apparatuses in which only dedicated software is run and are not used for performing operations and changes in a free manner. Secondly, the control apparatuses 20 perform communication with the controller present in the physical area 50, and perform monitoring and operations regarding the changes occurring in the physical phenomena of the sensor and the actuator that are connected to the controller. Hence, the control apparatuses 20 are required to collect the information within a predetermined period of time (for example, within one second), and perform the display and the operations. Thirdly, the control apparatus 20 are required to perform uninterrupted operations, and have a higher performance requirement of computer resources such as an arithmetic apparatus, a main memory apparatus, and a hard disk as compared to the computers used in the OA environment.

(Backup Apparatus 30)

The backup apparatus 30 is used for archiving the disk image backup of the control apparatuses in the operation hypervisors and the disk image backup of the control apparatuses 20 built with physical computers in the group of control system computers. In the backup apparatus 30, with the purpose of shortening the recovery time in case malfunctioning occurs in the control apparatus 20, the backup is taken for a certain period of time according to rules. Herein, in the backup apparatus 30, the backup is taken at the timing at which a function is added to the control apparatus 20 or at the timing at which the setting values are changed; or is taken at regular intervals such as during periodic repairs or on a monthly basis. However, there is no particular restriction on the timing of taking the backup.

(Clone Control Apparatuses 40)

The clone control apparatuses 40 are computers cloned from the backup image of the virtual computers or the physical computers present in the operation hypervisors. Regarding each clone control apparatus 40, depending on whether the backup source is a virtual computer or a physical computer, the destination for clone creation changes. For example, with reference to FIG. 1, the control apparatuses 20A and 20B representing virtual computers are cloned as a clone control apparatus 40-1 in the validation hypervisor; and the control apparatus 20Z representing a physical computer is cloned as a clone control apparatus 40-2 in a physical computer. However, there is no particular restriction as far as cloning is concerned. Meanwhile, the clone control apparatuses 40 are different than the control apparatuses 20 used for the operations in the group of control system computers; and need not be connected to the physical area 50. Moreover, the clone control apparatuses 40 need not be same in count and configuration as the computers running in the control system, as well as need not be kept operational at all times; and can be activated and used at arbitrary timings and for arbitrary periods of time.

(Physical Area 50)

In the physical area 50 of the control system, a controller is installed that is connected to the control apparatuses 20; a sensor is installed that is connected to the controller and that collects physical information; and an actuator is installed that is connected to the controller and that performs physical operations. However, there is no particular restriction on the apparatuses installed in the physical area 50.

[Overview of Conventional Security Validation]

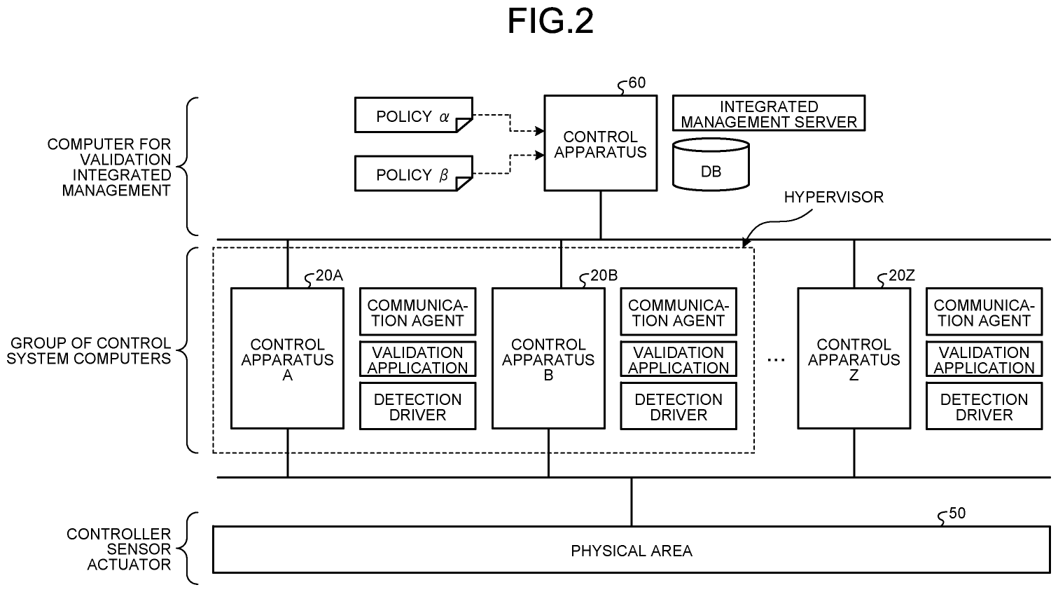

As the reference technology, explained below with reference to FIG. 2 is the overview of the conventional security validation that is commonly performed. FIG. 2 is a diagram illustrating the overview of the conventional security validation. Regarding the configuration and the functions identical to the security diagnosis system 100 according to the embodiment, the explanation is not given again.

For example, in the conventional security validation, the following is involved: a management apparatus 60 functioning as the computer for controlling the overall validation; the control apparatuses 20 (20A, 20B, . . . , 20Z) representing the group of control system computers; and the physical area 50 that includes a controller, a sensor, and an actuator.

The management apparatus 60 is a management computer involved for the purpose of security validation, and performs security-validation-related management of a plurality of computers to be subjected to security validation in the system. The management apparatus 60 has the functions of collecting the validation result, instructing validation, and updating the information required in validation. The management apparatus 60 needs to be able to send information to and receive information from the control apparatuses 20, and is installed in the same network in which the control apparatuses 20 are installed. Hence, the management apparatus 60 is required to have the operation policies and the security measures at an equivalent level to the control apparatuses 20.

Herein, policies α and β are electronic files required in the security validation that is implemented in an integrated management server provided in the management apparatus 60, and are distributed to the target computers for validation from the management apparatus 60. Moreover, the policies α and β are electronic files dedicated for use in a validation application installed in the control apparatuses 20, and need to be updated on a daily basis in order to keep up with the changes in the security threats.

An integrated management server has the function of listing, in the management apparatus 60, the security-validation-related information stored in a memory medium of the management apparatus 60, and has the function of communicating with the communication agents installed in the concerned target computers for validation.

Regarding each control apparatus 20, the corresponding communication agent has the function of communicating information with the integrated management server, and has the function of running the validation application. Upon receiving an instruction that is issued by the operator of the management apparatus 60 and that is received from the integrated management server 60; the control apparatus 20 updates the policies, performs security validation, and sends the result obtained by the validation application to the integrated management server of the management apparatus 60.

The validation application performs security validation in the control apparatus 20. The validation application uses the policies distributed from the integrated management server; monitors the OS, the general-purpose applications, the operations and the behavior of control software, and manual operations; detects unauthorized operations, malware execution, or malware reading; and prevents occurrence of threats. Moreover, the validation application also has the function of validating the electronic files stored in a hard disk and validating the memory, as well as has the function of autonomously finding suspicious data.

In each control apparatus 20, a detection drive is introduced along with the validation application for the purpose of security validation. The detection driver is introduced for implementing a mechanism in which the system calls of the OS are monitored; the operations of general-purpose application or the control system that made a system call are terminated; and those operations are reviewed using the validation application. When the validation application determines that there is no problem, the detection driver returns the operation control to the terminated application and enables it to perform the original operations.

In the conventional security validation of computer apparatuses as illustrated in FIG. 2, the security validation is performed using the integrated management server in the management apparatus 60 in combination with the communication agent, the validation application, and the detection driver in the concerned control apparatus 20. That is, during the security validation, the manual software operation or software operations (the system calls of the OS) such as auto-processing of a service program are captured using the detection driver; validation about whether or not the operations are normal is performed using the validation application; and, if the operations are determined to be normal, the captured operations are authorized so that the software can execute the originally-intended operations.

However, in the security validation explained above, due to the involvement of the detection driver and the validation application, there occurs a delay in the operations of the control software; and the normal operations get hindered due to the false detection performed by the validation application. Thus, in the security validation, it is difficult to reduce the impact exerted on the operations of the control system due to the introduction of the diagnosis system.

In contrast, as explained earlier, the diagnosis apparatus 10 illustrated in FIG. 1 includes the following: the master database 14 that is used to store, for each control apparatus 20 that performs control and monitoring of the apparatuses installed in the plant for the purpose of running the plant, the configuration information related to each configuration of the control apparatus 20 to be subjected to security diagnosis; the reception server 13 that receives, from each control apparatus 20, the diagnosis information of each configuration as collected by the control apparatus 20; and the diagnosis software 15 that performs security diagnosis of each control apparatus 20 based on the received diagnosis information and the configuration information.

That is, in the diagnosis apparatus 10, a mechanism and a method for dealing with security threats can be implemented while eliminating the impact exerted on the operations of the control system, such as operational delays, blocking of the operations, or termination of the operations of the control apparatuses, due to the introduction of the security validation system. Moreover, since it becomes easier to introduce the security diagnosis system in an existing control system, it also becomes possible to achieve independence of the control system and the security diagnosis system.

[Configuration of Diagnosis Apparatus]

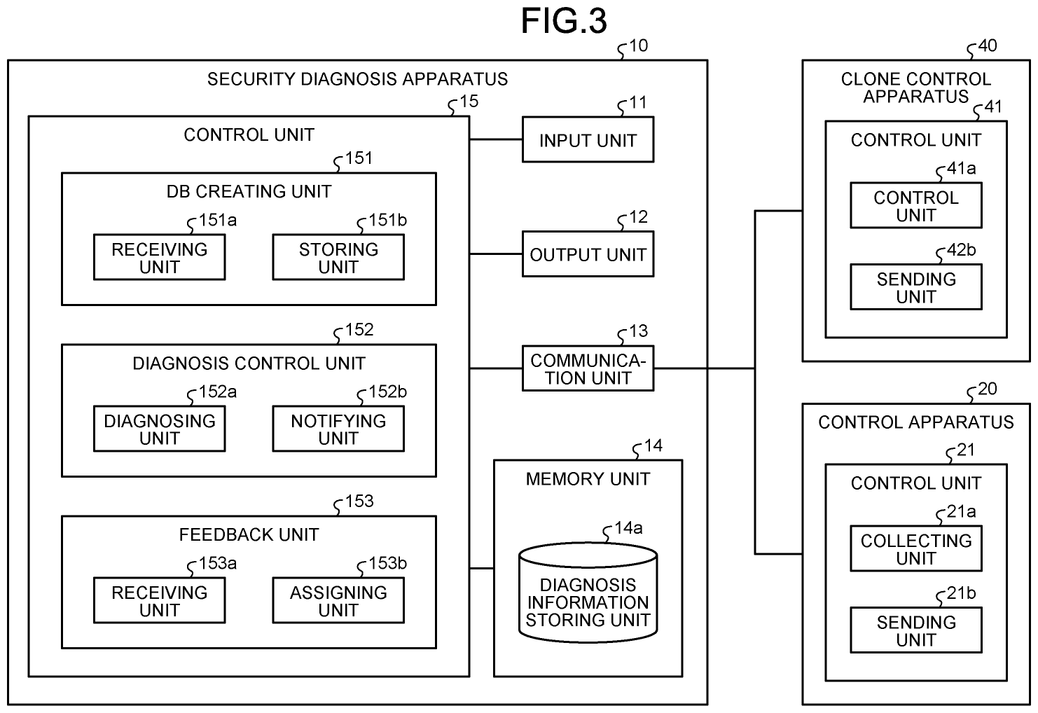

Explained below with reference to FIG. 3 is a detailed configuration of the security diagnosis apparatus 10 according to the embodiment. FIG. 3 is a block diagram illustrating an exemplary configuration of various apparatuses according to the embodiment. The following explanation is given about the configuration of the security diagnosis apparatus 10 and the configuration of the control apparatuses 20 (the clone control apparatuses 40) in that order.

(Configuration of Security Diagnosis Apparatus 10)

The security diagnosis apparatus 10 includes an input unit 11, an output unit 12, a communication unit 13, a memory unit 14, and a control unit 15. The input unit 11 is used for inputting a variety of information to the diagnosis apparatus 10. The input unit 11 is implemented using, for example, a mouse or a keyboard, and receives input of setting information for the diagnosis apparatus 10. The output unit 12 outputs a variety of information from the diagnosis apparatus 10. The output unit 12 is implemented using, for example, a display, and outputs the setting information stored in the diagnosis apparatus 10.

The communication unit 13 is responsible for the data communication with other apparatuses. For example, the communication unit 13 performs data communication with various communication apparatuses. Moreover, the communication unit 13 is capable of performing data communication with the terminal (not illustrated) of the operator.

The memory unit 14 is used to store a variety of information that is referred to by the control unit 15 during operations, and to store a variety of information obtained by the control unit 15 during operations. The memory unit 14 includes a diagnosis information storing unit 14a. The memory unit 14 can be implemented using, for example, a semiconductor memory apparatus such as a random access memory (RAM) or a flash memory; or a memory apparatus such as a hard disk or an optical disk. In the example illustrated in FIG. 3, the memory unit 14 is installed in the diagnosis apparatus 10. However, alternatively, the memory unit 14 can be installed on the outside of the diagnosis apparatus 10. Moreover, it is also possible to have a plurality of memory units.

The diagnosis information storing unit 14a is used to store, for each control apparatus 20 that performs control and monitoring of the apparatuses installed in the plant for the purpose of running the plant, the configuration information related to each configuration of the control apparatus 20 to be subjected to security diagnosis. The diagnosis information represents information collected by the collecting unit (the diagnosis information collection application) 21 of the control apparatus 20 or by the collecting unit (the diagnosis information collection application) 41 of the clone control apparatus 40 after the start of the security diagnosis. The configuration information represents the diagnosis information collected in advance for performing security diagnosis, and is stored for each control apparatus 20 to be subjected to security diagnosis.

The diagnosis information contains, for example, apparatus-specific information, system configuration information, processing information, network information, account information, file information, and customization information. However, there is no particular restriction on the diagnosis information.

The apparatus-specific information enables identification of the control apparatus. Examples of the apparatus-specific information include a computer ID, a host name, or a license number.

The system configuration information is related to the configuration of the hardware and the software in the computer and represents information about, for example, a central processing unit (CPU), a memory, a virtual memory, a hard disk, connected network apparatuses, portal memory area apparatuses that have been connected in the past, drivers, installed software, updating programs, and security patches.

The processing information represents the information about the running processes and the terminated processes in the computer. In the case of the running processes, the processing information indicates, for example, the memory consumption, the thread count, and the activation account.

The network information represents, for example, network-related setting information in the computer, and information related to the state of communication with the outside.

The account information represents, for example, information related to the user account present in the computer and the account information about the accounts that have accessed the computer in the past.

The file information represents, for example, the information about the electronic files stored in the memory apparatus of the computer, and indicates the size, the sum, and the hash value of the files and the folders.

The customization information is not defined in the information explained above, and is to be added to the diagnosis target.

The configuration information is of the same category and has the same details as the diagnosis information. Hence, that explanation is not given.

The control unit 15 performs overall control of the diagnosis apparatus 10. When functioning as a DB creating unit 151, the control unit 15 includes a receiving unit 151a and a storing unit 151b. Moreover, when functioning as a diagnosis control unit 152, the control unit 15 includes a diagnosing unit 152a and a notifying unit 152b. Furthermore, when functioning as a feedback unit 153, the control unit 15 includes a receiving unit 153a and an assigning unit 153b. The control unit 15 can be implemented, for example, using an electronic circuit such as a CPU or a micro processing unit (MPU), or using an integrated circuit such as an application specific integrated circuit (ASIC) or a field programmable gate array (FPGA).

The receiving unit 151a receives, from the control apparatus 20, the diagnosis information of each configuration as collected by the control apparatus 20. For example, the receiving unit 151a receives the diagnosis information of each configuration from: the virtual control apparatus 40-1 that is generated in a virtual machine using the disk image of the control apparatus 20 as obtained periodically by the backup apparatus 30; or the physical apparatus 40-2 in which the disk image of the control apparatus 20 is stored. Moreover, the receiving unit 151a periodically receives the diagnosis information of all configurations of the control apparatus 20. Furthermore, depending on the collection application that is resident and running in the control apparatus 20, the receiving unit 151a receives, at specified intervals, the diagnosis information collected at specified intervals from among the diagnosis information of all configurations of the control apparatus 20. Moreover, when any malfunctioning is detected by the control apparatus 20, the receiving unit 151a receives the diagnosis information of all configurations of the control apparatus 20 in which the malfunctioning is detected.

The storing unit 151b stores, in the memory unit 14, the diagnosis information of each configuration as received from the control apparatus 20. For example, as the diagnosis information of each configuration received from the control apparatus 20, the storing unit 151b stores the following information in the diagnosis information storing unit 14a: apparatus-specific information, system configuration information, process information, network information, account information, file information, and customization information.

Based on the received diagnosis information and the configuration information, the diagnosing unit 152a performs security diagnosis of the control apparatus 20. For example, the diagnosing unit 152a extracts the difference between the received diagnosis information and the configuration information, and outputs the difference. Moreover, the diagnosing unit 152a extracts the difference between the received diagnosis information and the concerned configuration information from among the configuration information, and outputs the difference.

The notifying unit 152b notifies the diagnosis result obtained by performing the security diagnosis. For example, the notifying unit 152b notifies the difference information of the security diagnosis to the security diagnosis result supervisor 90. Moreover, the notifying unit 152b can store the diagnosis result of the security diagnosis in the memory unit 14.

The receiving unit 153a receives the determination result obtained with respect to the diagnosis result of the security diagnosis. For example, as the determination result obtained with respect to the diagnosis result of the security diagnosis, the receiving unit 153a receives authorization of the difference, non-authorization of the difference, or temporary authorization of the difference. Meanwhile, the receiving unit 153a can store the diagnosis result of the security diagnosis in the memory unit 14.

The assigning unit 151b assigns predetermined information to the diagnosis result based on the received determination result. For example, when authorization of the difference is received, the assigning unit 151b assigns, to the diagnosis result, information indicating authorization of the difference. However, when non-authorization of the difference or temporary authorization of the difference is received, the assigning unit 151a assigns either unique information or the degree of importance to the diagnosis result. Moreover, the assigning unit 151b can send, to the security diagnosis result supervisor 90, the diagnosis result having predetermined information assigned thereto. Furthermore, the assigning unit 151b can store, in the memory unit 14, the diagnosis result having predetermined information assigned thereto.

(Configuration of Control Apparatus 20)

The control apparatus 20 includes, when functioning as a control unit 21, a collecting unit 21a and a sending unit 21b. Meanwhile, the configuration of the clone control apparatus 40 is identical to the configuration of the control apparatus 20. Hence, that explanation is not given.

The collecting unit 21a collects the diagnosis information of each configuration of the control apparatus 20. For example, the collecting unit 21a collects, on a periodic basis, the diagnosis information of each configuration of the control apparatus 20. Moreover, the collecting unit 21 collects the diagnosis information at specified intervals from among the diagnosis information of all configurations of the control apparatus 20. Furthermore, the collecting unit 21a collects the diagnosis information of all configurations of the control apparatus 20 in which malfunctioning is detected.

The sending unit 21b sends, to the diagnosis apparatus 10, the diagnosis information of each configuration of the control apparatus 20. For example, the sending unit 21b sends, to the diagnosis apparatus 10, the periodically-collected diagnosis information of each configuration of the control apparatus 20. Moreover, the sending unit 21b sends, to the diagnosis apparatus 10, the diagnosis information collected at specified intervals. Furthermore, the sending unit 21b sends, to the diagnosis apparatus 10, the diagnosis information collected in the control apparatus 20 in which malfunctioning is detected.

[Overall Flow of Security Diagnosis Operation]

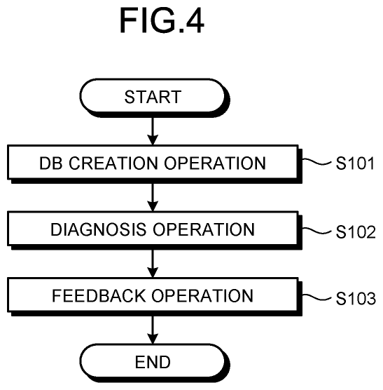

Explained with reference to FIG. 4 is the overall flow of the security diagnosis operation performed according to the embodiment. FIG. 4 is a flowchart for explaining an exemplary overall flow of the security diagnosis operation performed according to the embodiment. The security diagnosis operation performed according to the embodiment includes a DB creation operation (Step S101), a diagnosis operation (Step S102), and a feedback operation (Step S103) performed in that order. Regarding the operations performed from Step S101 to Step S103, the operations can be performed as individual operations, or the operations can be performed in a different order, or there can be skipped operations.

(DB Creation Operation)

The security diagnosis apparatus 10 performs a DB creation operation (Step S101). In the DB creation operation, for each control apparatus 20 that performs control and monitoring of the apparatuses installed in the plant for the purpose of running the plant, the diagnosis apparatus 10 receives the configuration information related to each configuration of the control apparatus 20 to be subjected to security diagnosis, and stores the configuration information in the memory unit 14. At that time, the diagnosis apparatus 10 can receive the diagnosis information of each configuration, which is collected by the control apparatus 20, either from the control apparatus 20, or from the virtual control apparatus 40-1 that is generated in a virtual machine using the disk image of the control apparatus 20 as obtained periodically by the backup apparatus 30, or from the physical apparatus 40-2 in which the disk image of the control apparatus 20 is stored.

(Configuration Related to DB Creation Operation)

The control apparatus 20 or the clone control apparatus 40 has the following configuration related to the DB creation operation. An operation screen is an application having a user interface meant for displaying a list of requests issuable to a request standby service; and, after a request is issued, receives an end notification/error notification from the request standby service.

The request standby service is a service program resident in the clone control apparatus 40, and receives a request from the operation screen and performs the decided operations. The requests provided by the request standby service include the following: a diagnosis information collection request (1. collecting information of the category specified by the source of the request; and 2. transferring the request from the operation screen to a diagnosis information collection integrated management service, waiting for the processing of the request, and sending the result to the operation screen); a diagnosis information transmission request (1. sending, to the diagnosis apparatus, the diagnosis information already collected in the clone control apparatus 40; and 2. transferring the request from the operation screen to a diagnosis information collection integrated management service, waiting for the processing of the request, and sending the result to the operation screen); auto-diagnosis start/end request (1. switching to the mode for automatic collection and transmission of diagnosis information, and automatically terminating the automatic mode; and 2. changing the operation mode of the diagnosis information collection integrated management service and a transmission management service); and service configuration information display/change request (sending the setting information of the diagnosis information collection integrated management service and the transmission management service to the operation screen, and receiving change information of the setting values from the operation screen and changing the setting of the services).

The diagnosis information collection integrated management service receives an instruction from the request standby service and controls the collection of information in the computer in which is the diagnosis information collection integrated management service is being executed. The diagnosis information collection integrated management service generates a thread for each request, and implements a diagnosis information collection function. Moreover, at the time of starting and ending the diagnosis information collection function, the diagnosis information collection integrated management service returns a response to the call source. Meanwhile, as a result of monitoring the current state of the CPU, the memory, and the disk access in the computer; if the set threshold values are attained, then the diagnosis information collection function is not implemented.

The diagnosis information collection function is meant for obtaining the information to be collected. The function is divided on the basis of the collection targets, and the diagnosis information collection integrated management service implements the function according to the request. The obtained diagnosis information is stored as an electronic file in the memory medium in the computer.

The diagnosis information represents an electronic file created by the diagnosis information collection function. The diagnosis information is read by a transmission data creation function, and is deleted after the transmission.

The transmission management service receives an instruction from the request standby service, and controls the operation of sending the diagnosis information already collected in the computer in which the transmission management service is being executed. Upon receiving a request, the transmission management service switches to the request queuing state and implements the transmission data creation function. After a single transmission request is completely processed, the transmission management service processes the next request in the queue. At the time of receiving a request, at the time of completing the creation of transmission data, and at the time of completing the transmission; the transmission management service returns a response to the call source. Meanwhile, the transmission management service monitors the current state of the memory and the disk access in the computer and, if the set threshold values are attained, does not perform the operation of sending the diagnosis information. Meanwhile, the information about the transmission destination is set based on the information included in a “request for updating the service configuration information” that is issued to the request standby service.

The transmission data creation function is implemented by the transmission management service. The transmission data creation function reads a diagnosis information file generated by the diagnosis information collection function, processes the diagnosis information file into transmission data to be sent using the transmission function, and implements the transmission function after the processing. Moreover, when the transmission function succeeds in transmission, the transmission data creation function deletes the diagnosis information file.

The transmission function is meant for sending the transmission data to the specified destination.

The diagnosis apparatus 10 has the following configuration related to the DB creation operation. A reception service is a service program resident in the diagnosis apparatus 10. The reception service receives the data sent from the transmission function of the clone control apparatus 40. Moreover, the reception service transfers the received data to the diagnosis information management service.

The diagnosis information management service is a service program resident in the diagnosis apparatus 10. The diagnosis information management service receives a request for reading or writing the diagnosis information, and returns a response to the call source. In the case of a writing request, the diagnosis information management service uses a received-information consistency confirmation function to determine whether or not the writing is possible, and outputs a writing request to a database management service. In the case of a reading request, the diagnosis information management service outputs a reading request of the specified data to the database management service, and returns the result to the source that issued the reading request.

The received-information consistency confirmation function is one of the functions used by the diagnosis information management service. The received-information consistency confirmation function determines whether or not the specified data can be handled in the diagnosis information management service. If the determination result indicates that there is a data loss or a format error, then the received-information consistency confirmation function implements the notification function and returns an error response. On the other hand, if the determination result indicates that there is no problem, then the received-information consistency confirmation function returns a response indicating usability.

The database management service is a service program resident in the diagnosis apparatus 10. The database management service receives a reading request or a writing request from the diagnosis information management service. In the case of a writing request, the database management service implements the notification function and notifies the result indicating success/failure.

A database access function is used by the database management service. The database access function accesses the database, and ensures reading and writing of the information.

The database 14 is used by the database access function.

The notification function is usable by the related services and functions in the diagnosis apparatus. When it is necessary to perform notification related to the security diagnosis in the diagnosis apparatus, the notification function is implemented to notify the result.

A management screen is a user interface capable of handling all information related to the security diagnosis performed by the diagnosis apparatus 10; and has the function of confirming the diagnosis information and the function of displaying the diagnosis result.

(Diagnosis Operation)

The security diagnosis apparatus 10 performs the diagnosis operation (Step S102). In the diagnosis operation, the diagnosis apparatus 10 receives, from the control apparatus 20, the diagnosis information of each configuration as collected by the control apparatus 20; and performs the security diagnosis of the control apparatus 20 based on the received diagnosis information and the configuration information. At that time, the diagnosis apparatus 10 can receive the diagnosis information of each configuration from: the virtual control apparatus 40-1 that is generated in a virtual machine using the disk image of the control apparatus 20 as obtained periodically by the backup apparatus 30; or the physical apparatus 40-2 in which the disk image of the control apparatus 20 is stored. Moreover, the diagnosis apparatus 10 can extract the difference between the received diagnosis information and the configuration information, and output the difference.

The diagnosis apparatus 10 performs three types of security diagnosis, namely, periodic diagnosis, normal diagnosis, and interim diagnosis. The three types of diagnosis differ in the way of the security diagnosis information to be collected and the collection interval. In the case of the periodic diagnosis, all of the diagnosis information is handled. In contrast, the normal diagnosis is performed with less processing load because it is targeted at the control apparatus 20 functioning as a control system computer. The interim diagnosis implies that the diagnosis operation to be originally performed during the periodic diagnosis is performed in the control apparatus 20.

The periodic diagnosis is performed using the clone control apparatus 40 at the timing at which the image backup of the control apparatus 20, which is stored in the backup apparatus 30, is updated. In the periodic diagnosis, all of the security diagnosis information is collected and sent to the diagnosis apparatus 10. The diagnosis apparatus 10 compares the received security diagnosis information with the information registered in the configuration information master DB 14, and stores difference information. When the periodic-diagnosis information of the target control apparatus is confirmed in the management screen, the difference information generated as above is displayed.

The normal diagnosis is performed using the diagnosis information collection application 21 that is resident and running in each control apparatus 20. The diagnosis information is collected at the specified collection interval, and is sequentially sent to the reception server 13 of the diagnosis apparatus 10. The diagnosis apparatus 10 compares the received diagnosis information with the information registered in the configuration information master DB 14, and records the difference information. Moreover, when a difference is confirmed to be present, a notification of the occurrence of the difference is issued using the notifying function, and it is prompted to confirm the difference using the management screen of the diagnosis apparatus 10.

The interim diagnosis is performed when the operator of the control apparatus 20 confirms malfunctioning in the control apparatus 20. If no abnormal changes can be confirmed from the diagnosis result of the normal diagnosis but if there is a report of malfunctioning from the operator, then the interim diagnosis is performed by keeping the control apparatus 20 in the state of being usable for diagnosis. Moreover, in an identical manner to the case of the periodic diagnosis, all of the security diagnosis information is collected and sent to the diagnosis apparatus 10. The subsequent flow of operations is identical to the periodic diagnosis.

(Configuration Related to Diagnosis Operation)

The control apparatus 20 or the clone control apparatus 40 has the following configuration related to the diagnosis operation. Regarding the operation screen, in the periodic diagnosis/interim diagnosis, after a request for starting the diagnosis is sent to the request standby service running in the control apparatus 20 or the clone control apparatus 40; a completion notification or an error notification is received at the point of time when the collection of the security diagnosis information and the transmission to the diagnosis apparatus 10 is completed. Moreover, regarding the operation screen, in the normal diagnosis, after a request for starting the diagnosis is sent to the request standby service, a reception completion notification or an error notification is received instantly.

The diagnosis apparatus 10 has the following configuration related to the diagnosis operation. The diagnosis information management service implements the received-information consistency confirmation function and, in an identical manner to the configuration information master DB creation, confirms the information received by the reception service. When the consistency is confirmed, the diagnosis information management service implements a difference checking function and starts comparing the difference between the configuration information master DB and the reception data.

The difference checking function is called from the diagnosis information management service, and then the difference is compared according to the following procedure. Firstly, the difference checking function identifies the target apparatus for difference comparison by referring to the received apparatus-specific information. Secondly, the difference checking function identifies the target value for difference comparison from the category of the received diagnosis information. Thirdly, the difference checking function uses the identified information and sends a request to the database management service for obtaining the diagnosis result of the past. Fourthly, the difference checking function compares the received diagnosis result of the past with the current diagnosis information. Fifthly, the difference checking function extracts the difference that is found, and registers it as difference information in the database management service. Sixthly, the difference checking function notifies the difference information using the notification function.

When a difference is detected in all types of diagnosis, namely, the normal diagnosis, the periodic diagnosis, and the interim diagnosis; the fact that the difference is detected is displayed in the management screen, thereby enabling confirmation of detailed difference information in a state confirmation screen provided for each control apparatus. Meanwhile, after finding out about the difference detection in the management screen, the security diagnosis result supervisor can confirm and determine the state of each control apparatus.

(Feedback Operation)

The security diagnosis apparatus 10 performs the feedback operation (Step S103). In the feedback operation, the diagnosis apparatus 10 receives the determination result with respect to the result of security diagnosis, and assigns predetermined information to the diagnosis result based on the received determination result. Herein, the diagnosis apparatus 10 can receive, as the determination result, authorization of the difference, non-authorization of the difference, or temporary authorization of the difference. When authorization of the difference is received, the diagnosis apparatus 10 assigns information indicating authorization of the difference in the diagnosis result. However, when non-authorization of the difference or temporary authorization of the difference is received, the diagnosis apparatus 10 assigns unique information or the degree of information to the diagnosis result.

The security diagnosis result supervisor 90 can perform feedback of the determination result about the difference. There are three types of determination results that can be feedbacked, namely, “recognize/authorize the difference”, “do not recognize/authorize the difference”, and “temporarily authorize the difference”. In the case of not recognizing/authorizing the difference or temporarily authorizing the difference, unique information and weighting can be assigned to the detected difference.

In the case of recognizing/authorizing the difference, with respect to the information registered in the configuration information master DB 14 (i.e., the past results), even if there is a difference in the received dialogue information, the difference is selected as long as it is the anticipated difference. Regarding each control apparatus 20 running in the group of control system computers, the image backup immediately before the operations is generated in the backup apparatus 30, and the security diagnosis information is registered in the configuration information master DB. When any changes are to be made in any control apparatus 20, the post-change result is generated in the image backup in the backup apparatus 30. In the post-change clone control apparatus 40, when the periodic diagnosis is performed, the generated difference is recognized because the changes are intended. In the normal diagnosis performed in the control apparatus 20 that is in operation, sometimes the diagnosis information that reaches is greater or smaller in volume than the information registered in the configuration information master DB 14. The diagnosis information can have a certain range; and, in a particular state, sometimes information exceeding the range registered in the configuration information master DB 14 is obtained. When that range is permissible, the difference is authorized and is no more treated as the difference from the next time onward.

In the case of not recognizing/authorizing the difference, with respect to the information registered in the configuration information master DB 14 (i.e., the past results), even if there is a difference in the received dialogue information, the difference information is selected as long as it is not recognized or cannot be authorized. In each control apparatus 20 running in the group of control system computers, changes in the configuration are not to be freely made while in operation, and are made as may be necessary under the authorization of the system administrator. In comparison with the normal diagnosis information of the control apparatus 20, if any unauthorized change is detected, confirmation is taken with the system administrator and the background of the change is traced. If the cause becomes clear, then the change is treated as an unauthorized change; the cause is written with respect to the detected difference using an optional format; the degree of importance is set; and the information is put to use in the analysis in the case of the subsequent occurrence of a difference or the occurrence of the same problem in some other control apparatus 20. The diagnosis information also contains information having a certain range, In that case, when the upper limit or the lower limit of the range is exceeded, it is detected as the difference. If that result cannot be authorized, a mark indicating non-authorization is put; the determination reason is written in an optional format; and the degree of importance is set. That information can be put to use in the case of the subsequent occurrence of a difference or the occurrence of the same problem.

In the case of temporarily authorizing the difference, when the determination of authorization cannot be done, the difference is selected when it is to be authorized until a specified date. That state is set when the cause cannot be identified but when it is determined there is no problem from the security perspective. If the cause can be identified in the subsequent examination, either the state of authorization or the state of non-authorization is again set. In the case of temporary authorization, the cause is written with respect to the detected difference using an optional format; the degree of importance is set; and the information is put to use in the analysis in the case of reoccurrence of an identical difference.

(Configuration Related to Feedback Operation)

The diagnosis apparatus 10 has the following configuration related to the feedback operation. A management screen is a computer program having a user interface to be operated by the security diagnosis result supervisor. Firstly, when “management screen” is selected, a request is sent to the diagnosis information management service, and apparatus-specific identification information and the information about the presence or absence of the difference is obtained from a database; and the information is put up in the user interface. Secondly, from “management screen”, when “difference detail information” for a particular control apparatus is selected, the request is sent to the same service, and the difference information of the security diagnosis result of the target control apparatus is obtained and is put up in the user interface. Thirdly, in the screen in which the difference detail information is displayed, the determination result is input and a registration operation is performed, so that the request is sent to the same service and the determination result is registered in the database.

The diagnosis information management service operates in response to a request from the management screen. According to the obtained information, the diagnosis information management service obtains/processes the information of the database using the database management service or the difference checking function. Moreover, the diagnosis information management service puts up the execution result in the user interface of the management screen.

[Flow of DB Creation Operation]

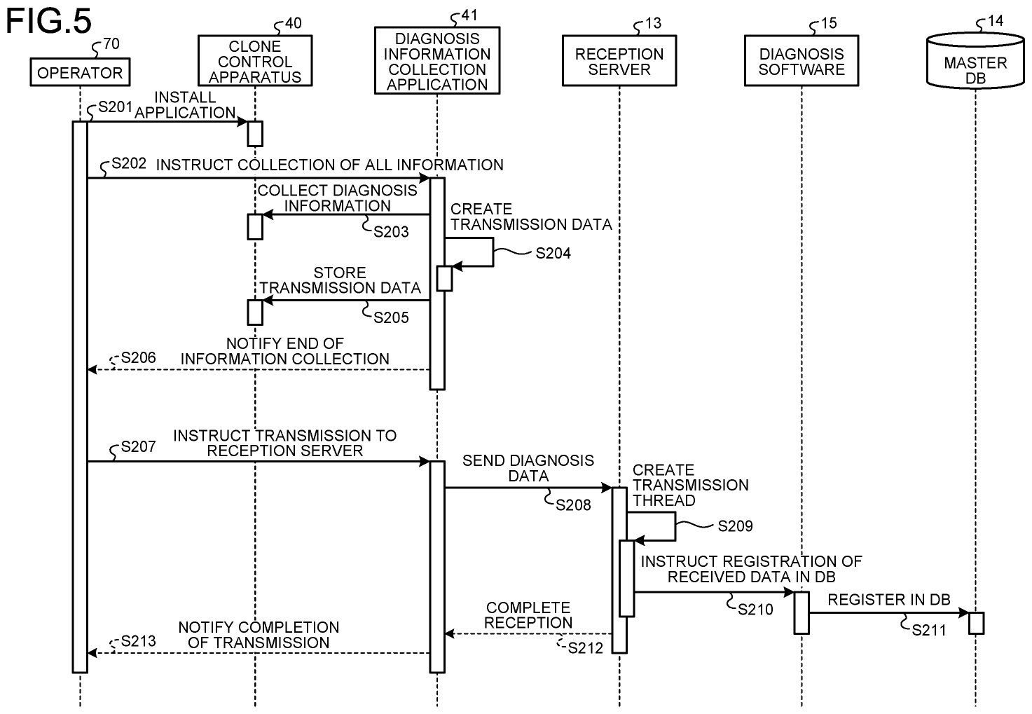

Explained below with reference to FIG. 5 is the detailed flow of the DB creation operation performed according to the embodiment. FIG. 5 is a sequence diagram illustrating an exemplary flow of the DB creation operation according to the embodiment. The following explanation is given about a collection operation (Step S201 to Step S206) and a registration operation (Step S207 to Step S213) in that order.

(Collection Operation)

Firstly, an operator 70 such as the system administrator installs the diagnosis information collection application 41 in the clone control apparatus 40 (Step S201). Moreover, the operator 70 instructs the clone control apparatus 40 to collect all information (Step S202). In response, the diagnosis information collection application 41 in the clone control apparatus 40 collects diagnosis information (Step S203). Moreover, the diagnosis information collection application 41 creates transmission data of the diagnosis information (Step S204), and stores it in the clone control apparatus 40 (Step S205). At that time, the diagnosis information collection application 41 notifies the operator 70 about the end of information collection (Step S206).

(Registration Operation)

Firstly, the operator 70 such as the system administrator instructs the diagnosis information collection application 41 in the clone control apparatus 40 to send diagnosis data to the reception server 13 (Step S207). In response, the diagnosis information collection application 41 sends the diagnosis data to the reception server 13 (Step S208). The reception server 13 creates a transmission thread (Step S209), and instructs the diagnosis software 15 to register the received data in a DB (Step S210). Then, the diagnosis software 15 registers the received data in the master DB 15 (Step S211). Moreover, the reception server 13 notifies the diagnosis information collection application 41 about the end of reception of the diagnosis data (Step S212). The diagnosis information collection application 41 notifies the operator 70 about the completion of transmission of the diagnosis data (Step S213). It marks the end of the operations.

[Flow of Diagnosis Operation]

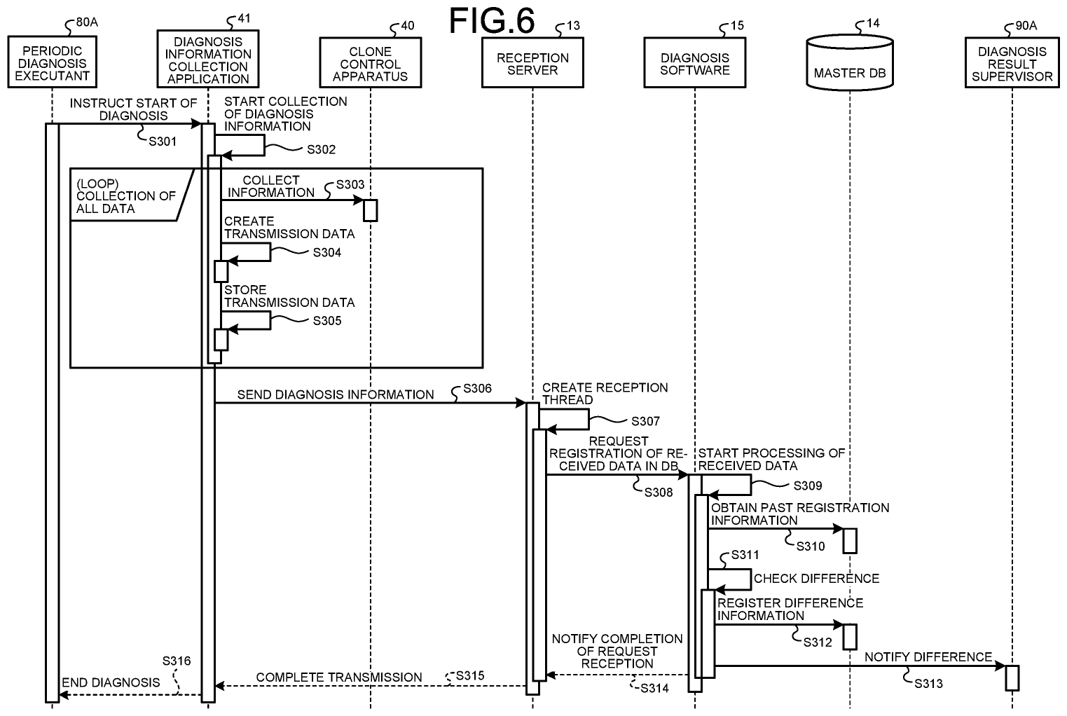

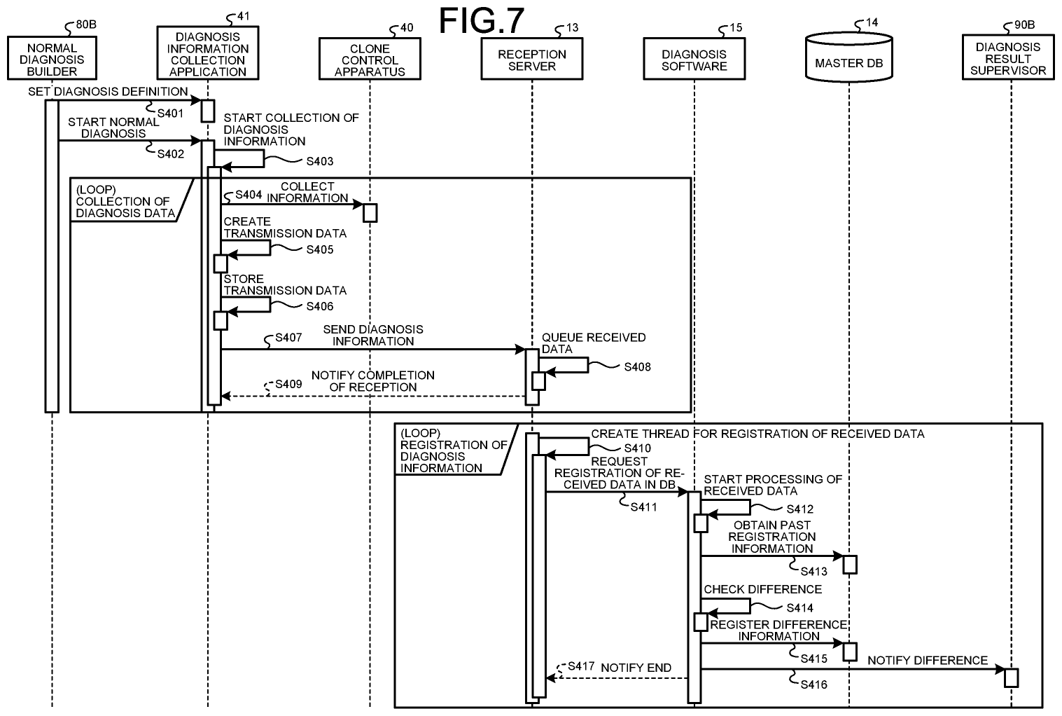

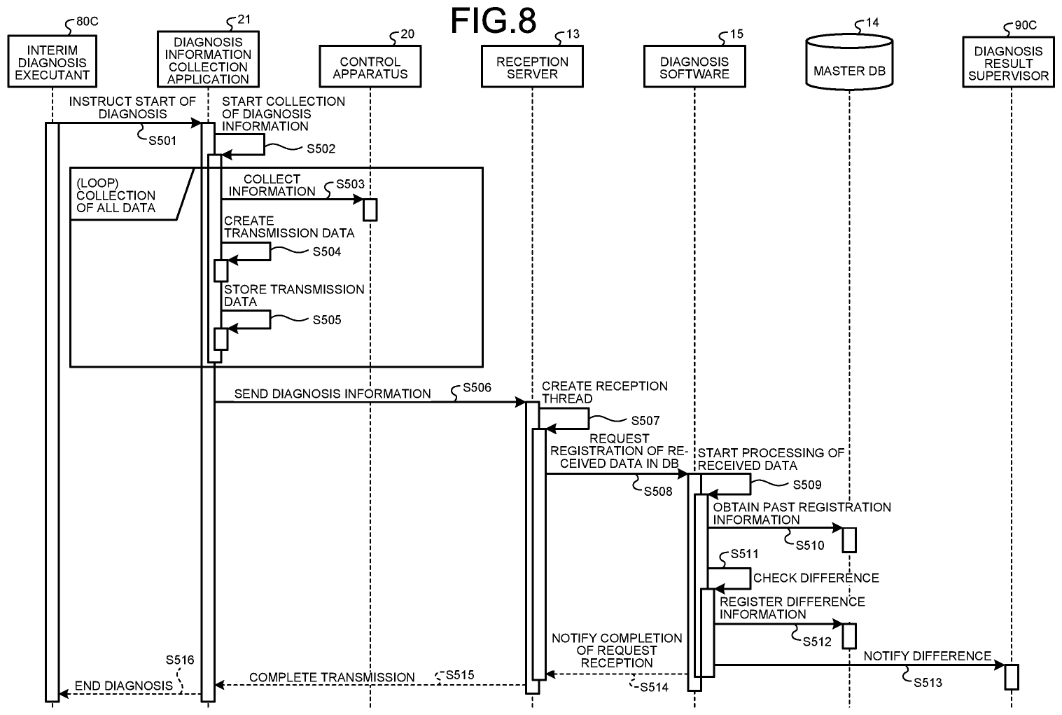

Explained below with reference to FIGS. 6 to 8 is the detailed flow of the diagnosis operation performed according to the embodiment. FIG. 6 is a sequence diagram illustrating an exemplary flow of the periodic diagnosis operation performed according to the embodiment. FIG. 7 is a sequence diagram illustrating an exemplary flow of the normal diagnosis operation performed according to the embodiment. FIG. 8 is a sequence diagram illustrating an exemplary flow of the interim diagnosis operation performed according to the embodiment. Thus, the following explanation is given in the order of the periodic diagnosis operation, the normal diagnosis operation, and the interim diagnosis operation.

(Periodic Diagnosis Operation)

Explained below with reference to FIG. 6 is the detailed flow of the periodic diagnosis operation performed according to the embodiment. The following explanation is given about a collection operation (Step S301 to Step S305) and a registration operation (Step S306 to Step S316) in that order.

(Collection Operation in Periodic Diagnosis Operation)

Firstly, a periodic diagnosis executant 80A such as the system administrator instructs the diagnosis information collection application 41 in the clone control apparatus 40 to start the diagnosis (Step S301). In response, the diagnosis information collection application 41 starts collecting the diagnosis information (Step S302). At that time, the diagnosis information collection application 41 collects information (Step S303), creates transmission data (Step S304), and stores the transmission data (Step S305). In the periodic diagnosis operation, the operations from Step S303 to Step S305 are repeatedly performed until the collection of all of the configuration data is completed.

(Difference Information Generation Operation in Periodic Diagnosis Operation)

Firstly, the diagnosis information collection application 41 in the clone control apparatus 40 sends the diagnosis information to the reception server 13 (Step S306). Then, the reception server 13 creates a reception thread (Step S307), and requests the diagnosis software 15 to register the received data in a DB (Step S308). Then, the diagnosis software 15 starts processing the reception data (Step S309), obtains the past registration information from the master DB (Step S310), performs difference checking (Step S311), registers the difference information in the master DB (Step S312), and notifies a diagnosis result supervisor 90A such as the system administrator about the difference information (Step S313). Moreover, the diagnosis software 15 notifies the reception server 13 about the end of request reception (Step S314). The reception server 13 notifies the diagnosis information collection application 41 about the completion of transmission of the received data (Step S315). Lastly, the diagnosis information collection application 41 notifies the periodic diagnosis executant 80A about the end of diagnosis (Step S316). It marks the end of the operations.

(Normal Diagnosis Operation)

Explained below with reference to FIG. 7 is the detailed flow of the normal diagnosis operation performed according to the embodiment. The following explanation is given about a collection operation (Step S401 to Step S409) and a difference information generation operation (Step S410 to Step S417) in that order.

(Collection Operation in Normal Diagnosis Operation)

Firstly, a normal diagnosis builder 80B such as the system administrator sets a diagnosis definition in the diagnosis information collection application 41 in the clone control apparatus 40 (Step S401), and starts the normal diagnosis (Step S402). In response, the diagnosis information collection application 41 starts collecting the diagnosis information (Step S403). At that time, the diagnosis information collection application 41 collects information (Step S404), creates transmission data (Step S405), stores the transmission data (Step S406), and sends the diagnosis information to the reception server 13 (Step S407). The reception server 13 queues the received data (Step S408), and notifies the diagnosis information collection application 41 about the end of reception of the diagnosis information (Step S409). In the normal diagnosis operation, the operations from Step S404 to Step S409 are repeatedly performed until the collection of the diagnosis data is completed.

(Difference Information Generation Operation in Normal Diagnosis Operation)

Firstly, the reception server 13 creates a thread for registration of the received data (Step S410), and requests the diagnosis software 15 to register the received data in a DB (Step S411). In response, the diagnosis software 15 starts processing the received data (Step S412), obtains the past registration information from the master DB (Step S413), performs difference checking (Step S414), registers the difference information in the master DB (Step S415), and notifies a diagnosis result supervisor 90B such as the system administrator about the difference information (Step S416). Then, the diagnosis software 15 notifies the reception server 13 about the end of the operations (Step S417). In the normal diagnosis operation, the operations from Step S410 to Step S417 are repeatedly performed until the registration of the diagnosis information is completed.

(Interim Diagnosis Operation)

Explained below with reference to FIG. 8 is the detailed flow of the interim diagnosis operation according to the embodiment. The following explanation is given about a collection operation (Step S501 to Step S505) and a difference information generation operation (Step S506 to Step S516) in that order.

(Collection Operation in Interim Diagnosis Operation)

Firstly, an interim diagnosis executant 80C such as the system administrator instructs the diagnosis information collection application 21 in the control apparatus 20 to start the diagnosis (Step S501). In response, the diagnosis information collection application 21 starts collecting the diagnosis information (Step S502). At that time, the diagnosis information collection application 21 collects information (Step S503), creates transmission data (Step S504), and stores the transmission data (Step S505). In the interim diagnosis operation, the operations from Step S503 to Step S505 are repeatedly performed until the collection of all of the configuration data is completed.

(Difference Information Generation Operation in Interim Diagnosis Operation)

Firstly, the diagnosis information collection application 21 in the control apparatus 20 sends the diagnosis information to the reception server 13 (Step S506). Then, the reception server 13 creates a reception thread (Step S507), and requests the diagnosis software 15 to register the received data in a DB (Step S508). In response, the diagnosis software 15 starts processing the received data (Step S509), obtains the past registration information from the master DB (Step S510), performs difference checking (Step S511), registers the difference information in the master DB (Step S512), and notifies a diagnosis result supervisor 90C such as the system administrator about the difference information (Step S513). Moreover, the diagnosis software 15 notifies the reception server 13 about the end of request reception (Step S514). The reception server 13 notifies the diagnosis information collection application 21 about the completion of transmission of the received data (Step S515). Lastly, the diagnosis information collection application 21 notifies the interim diagnosis executant 80C about the end of the diagnosis (Step S516). It marks the end of the operations.

[Flow of Feedback Operation]

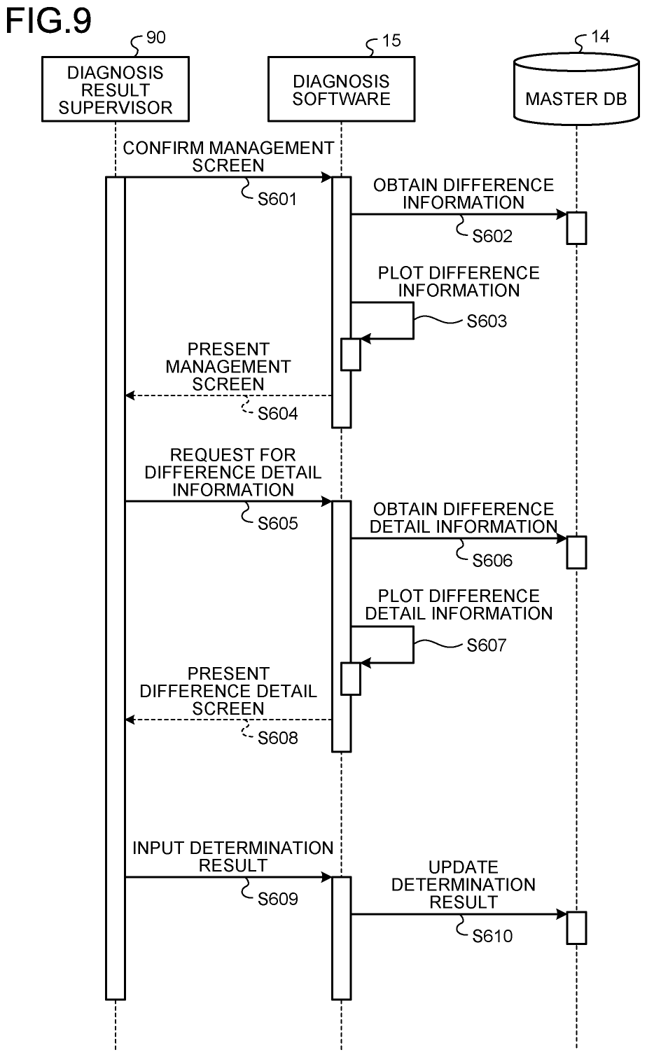

Explained below with reference to FIG. 9 is the detailed flow of the feedback operation performed according to the embodiment. FIG. 9 is a sequence diagram illustrating an exemplary flow of the feedback operation performed according to the embodiment. The following explanation is given about a management screen presentation operation (Step S601 to Step S604), a difference detail screen presentation operation (Step S605 to Step S608), and a determination result updating operation (Steps S609 and S610) in that order.

(Management Screen Presentation Operation)

Firstly, the diagnosis result supervisor 90 such as the system administrator instructs the diagnosis software 15 in the diagnosis apparatus 10 to confirm the management screen (Step S601). In response, the diagnosis software 15 obtains the difference information from the master DB (Step S602), and plots the difference information (Step S603). Then, the diagnosis software 15 presents the management screen to the diagnosis result supervisor 90 (Step S604).

(Difference Detail Screen Presentation Operation)

Firstly, the diagnosis result supervisor 90 such as the system administrator requests the diagnosis software 15 in the diagnosis apparatus 10 for the difference detail information (Step S605). Then, the diagnosis software 15 obtains the difference detail information from the master DB (Step S606), and plots the difference detail information (Step S607). Then, the diagnosis software 15 presents a difference detail screen to the diagnosis result supervisor 90 (Step S608).

(Determination Result Updating Operation)

Firstly, the diagnosis result supervisor 90 such as the system administrator inputs the determination result to the diagnosis software (Step S609). Then, the diagnosis software 15 updates the determination result in the master DB (Step S610). It marks the end of the operations.

### Effects of Embodiment

Firstly, in the security diagnosis operation performed according to the embodiment described above, for each control apparatus 20 that performs control and monitoring of the apparatuses installed in the plant for the purpose of running the plant, the configuration information related to each configuration of the control apparatus 20 to be subjected to security diagnosis is stored; the diagnosis information of each configuration as collected by the control apparatus 20 is received from the control apparatus 20; and security diagnosis of the control apparatus 20 is performed based on the received diagnosis information and the configuration information. Hence, in the security diagnosis, it becomes possible to reduce the impact exerted on the operations of the control system due to the introduction of the diagnosis system.

Secondly, in the security diagnosis operation performed according to the embodiment, the diagnosis information of each configuration is received from the virtual control apparatus 40-1, which is generated by a virtual machine using the disk image of the control apparatus 20 as periodically obtained by the backup apparatus 30, or from the physical apparatus 40-2 that holds the disk image of the control apparatus 20. Hence, in the security diagnosis, the execution of applications in the control apparatus 20 is not hindered, and it becomes possible to reduce the impact exerted on the operations of the control system due to the introduction of the diagnosis system.

Thirdly, in the security diagnosis operation performed according to the embodiment, the diagnosis information of all configurations of the control apparatus 20 are periodically received; the difference between the received diagnosis information and the configuration information is extracted; and the difference is output. Hence, in the security diagnosis performed on a periodic basis, it becomes possible to reduce the impact exerted on the operations of the control system due to the introduction of the diagnosis system.

Fourthly, in the security diagnosis operation according to the embodiment, from among the diagnosis information of all configurations of the control apparatus 20, the collection application 21 that is resident and running in the control apparatus 20 receives, at the specified intervals, the diagnosis information collected at the specified intervals; extracts the difference between the received diagnosis information and the concerned configuration information from among the configuration information; and outputs the difference. Hence, in the normal security diagnosis, it becomes possible to reduce the impact exerted on the operations of the control system due to the introduction of the diagnosis system.

Fifthly, in the security diagnosis operation performed according to the embodiment, when malfunctioning is detected by any control apparatus 20, the diagnosis information of all configurations is received from that control apparatus 20 in which malfunctioning is detected. Then, the diagnosis unit extracts the difference between the received diagnosis information and the configuration information. Hence, in the interim security diagnosis, it becomes possible to reduce the impact exerted on the operations of the control system due to the introduction of the diagnosis system.

Sixthly, in the security diagnosis operation performed according to the embodiment, the determination result with respect to the diagnosis result of the security diagnosis is received, and predetermined information is assigned to the diagnosis result based on the received determination result. Hence, in the security diagnosis, as a result of performing the feedback, it becomes possible to reduce the impact exerted on the operations of the control system due to the introduction of the diagnosis system.

Seventhly, in the security diagnosis operation performed according to the embodiment, either authorization of the difference, or non-authorization of the difference, or temporary authorization of the difference is received as the determination result with respect to the diagnosis result of the security diagnosis. When authorization of the difference is received, information authorizing the difference is assigned to the diagnosis result. When non-authorization of the difference or temporary authorization of the difference is received, either unique information or the degree of importance is assigned to the diagnosis result. Hence, in the security diagnosis, as a result of performing the feedback, it becomes possible to reduce the impact exerted on the operations of the control system due to the introduction of the diagnosis system.

[System]

The processing procedures, the control procedures, specific names, various data, and information including parameters described in the embodiment or illustrated in the drawings can be changed as required unless otherwise specified.

The constituent elements of the apparatus illustrated in the drawings are merely conceptual, and need not be physically configured as illustrated. The constituent elements, as a whole or in part, can be separated or integrated either functionally or physically based on various types of loads or use conditions.

The process functions implemented in the apparatus are entirely or partially implemented by a CPU or by computer programs that are analyzed and executed by a CPU, or are implemented as hardware by wired logic.

[Hardware]

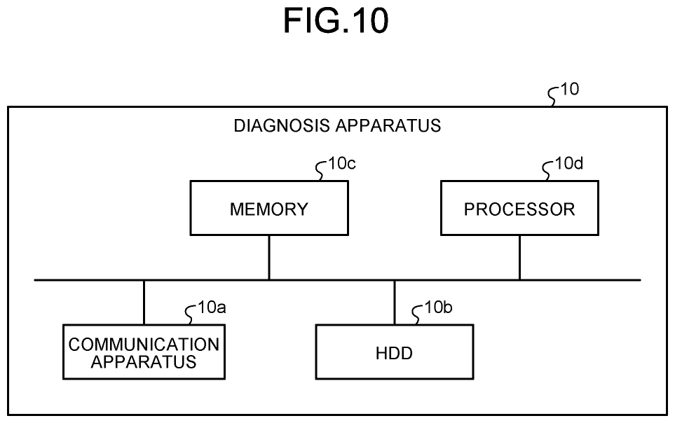

Given below is the explanation of an exemplary hardware configuration of the diagnosis apparatus 10. The other apparatuses too can have an identical hardware configuration. FIG. 10 is a diagram illustrating an exemplary hardware configuration. As illustrated in FIG. 10, the diagnosis apparatus 10 includes a communication apparatus 10a, a hard disk drive (HDD) 10b, a memory 10c, and a processor 10d. The constituent elements illustrated in FIG. 10 are connected to each other by a bus.

The communication apparatus 10a is a network interface card that performs communication with other servers. The HDD 10b is used to store a computer program meant for implementing the functions illustrated in FIG. 3, and to store databases.

The processor 10d reads the computer program, which performs identical operations to the operating units illustrated in FIG. 3, from the HDD 10b, and loads it in the memory 10c; and runs a process for implementing the functions explained with reference to FIG. 3. For example, the process implements the functions identical to the operating units of the diagnosis apparatus 10. More particularly, the processor 10d reads, from the HDD 10b, the computer program having the functions identical to the receiving unit 151a, the storing unit 151b, the diagnosing unit 152a, the notifying unit 152b, the receiving unit 153a, and the assigning unit 153b.

In this way, the diagnosis apparatus 10 reads and executes the computer program, and operates as an information processing apparatus that implements various processing methods. Alternatively, the diagnosis apparatus 10 can read the computer program from a recording medium using a medium reading apparatus, and can execute the read computer program so as to implement the functions as described above in the embodiment. Meanwhile, the computer program is not limited to be executed by the diagnosis apparatus 10. Alternatively, for example, even when some other computer or some other server executes the computer program or even when such apparatuses execute the computer program in cooperation, the present invention can be implemented in an identical manner.

The computer program can be distributed via a network such as the Internet. Alternatively, the computer program can be recorded in a computer-readable recording medium such as a hard disk, a flexible disk (FD), a compact disk read only memory (CD-ROM), a magneto-optical (MO) disk, or a digital versatile disk (DVD). Then, a computer can read the computer program from the recording medium and execute it. Furthermore, the recording medium having the control program stored therein, which is described above with reference to, for example, FIG. 10, also forms an embodiment.

What is claimed is:

1. A diagnosis apparatus comprising:
a memory unit that, for each control apparatus which performs control and monitoring of an apparatus installed in a plant for running the plant, is used to store configuration information related to each configuration of the control apparatus to be subjected to security diagnosis;
a receiving unit that receives, from the control apparatus, diagnosis information of the each configuration as collected by the control apparatus; and
a diagnosing unit that performs security diagnosis of the control apparatus based on the received diagnosis information and the configuration information.

2. The diagnosis apparatus according to claim 1, wherein the receiving unit receives the diagnosis information of the each configuration from a virtual control apparatus that is generated by a virtual machine using disk image of the control apparatus as obtained by a backup apparatus on a periodic basis, or
a physical apparatus that holds disk image of the control apparatus.

3. The diagnosis apparatus according to claim 1, wherein
the receiving unit periodically receives diagnosis information of all configurations of the control apparatus, and
the diagnosing unit extracts difference between the received diagnosis information and the configuration information, and outputs the difference.

4. The diagnosis apparatus according to claim 1, wherein
the receiving unit receives, at specified intervals and from diagnosis information of all configurations of the control apparatus, diagnosis information collected at the intervals by a collection application that is resident and running in the control apparatus, and
the diagnosing unit extracts difference between the received diagnosis information and concerned configuration information from among the configuration information, and outputs the difference.

5. The diagnosis apparatus according to claim 1, wherein
when malfunctioning is detected by the control apparatus, the receiving unit receives the diagnosis information of all configurations of the control apparatus in which malfunctioning is detected, and
the diagnosing unit extracts difference between the received diagnosis information and the configuration information, and outputs the difference.

6. The diagnosis apparatus according to claim 1, further comprising:
a receiving unit that receives determination result with respect to diagnosis result of the security diagnosis; and
an assigning unit that assigns predetermined information to the diagnosis result based on the received determination result.

7. The diagnosis apparatus according to claim 6, wherein
the receiving unit receives either authorization of difference, or non-authorization of difference, or temporary authorization of difference as the determination result,
when authorization of the difference is received, the assigning unit assigns, to the diagnosis result, information authorizing the difference, and
when non-authorization of the difference or temporary authorization of the difference is received, the assigning unit assigns either unique information or degree of importance to diagnosis result.

8. A diagnosis method implemented in a computer, comprising:
storing, for each control apparatus which performs control and monitoring of an apparatus installed in a plant for running the plant, configuration information related to each configuration of the control apparatus to be subjected to security diagnosis;
receiving, from the control apparatus, diagnosis information of the each configuration as collected by the control apparatus; and
performing security diagnosis of the control apparatus based on the received diagnosis information and the configuration information.

9. A computer-readable recording medium having stored therein a control program configured to cause a computer to execute:
storing, for each control apparatus which performs control and monitoring of an apparatus installed in a plant for running the plant, configuration information related to each configuration of the control apparatus to be subjected to security diagnosis;
receiving, from the control apparatus, diagnosis information of the each configuration as collected by the control apparatus; and
performing security diagnosis of the control apparatus based on the received diagnosis information and the configuration information.
